(19) United States
(12) Patent Application Publication
(10) Pub. No.: US 2011/0315510 A1
(43) Pub. Date: Dec. 29, 2011

(54) TRANSPORT DEVICE FOR FLAT PRODUCTS

(76) Inventors: Stefano Palamides, Grafenau (DE); Cristovao Mesquita, Leonberg (DE); Martin Schweitzer, Schwieberdingen (DE)

(21) Appl. No.: 13/166,224

(22) Filed: Jun. 22, 2011

(30) Foreign Application Priority Data
Jun. 23, 2010 (DE) 10 2010 025 223.9

(51) Int. Cl. B65G 37/00; B65G 47/31; B65G 47/82; B65G 47/04

(52) U.S. Cl. 198/419.2; 198/604; 198/597

(57) ABSTRACT

A device and a method for transporting flat products comprising at least one feeder and a first transport unit having at least two transport elements that can be set against side edges lying opposite one another of the flat products. The flat products can be gripped by the transport elements and can be transported upright in the transport direction. In the transporting process, the flat products are received in the first transport unit, are transported within the latter, and are held upright at the side edges by the transport elements.

### BACKGROUND OF THE INVENTION

The present invention relates to a device for transporting flat products, in particular flat products such as envelopes.

Devices of this type are used, for example, by relatively large companies with a large amount of mail items. These companies include, for example, large telecommunications enterprises with a large number of invoices to be sent, insurance enterprises, enterprises which use a lot of advertising and have a large amount of letter post to be sent, which is to be produced, placed in envelopes and sent automatically.

To this end, the letters, after they have been printed, are transferred automatically into envelopes in what is known as an enveloping machine, and the envelopes are subsequently sealed. In this form, the envelopes come out of the enveloping machine with different types of contents, that is to say both letters with many and few pages, brochures with a thick folded edge and the like.

After this, the letters as a rule already pass onto a conveyor belt, after which they are picked up manually, according to certain criteria, by persons standing at this conveyor belt and are transferred into transport boxes.

These transport boxes are then delivered correspondingly to the respective mail or delivery enterprise which then deals with the dispatch of the corresponding letters. In order that the outlay at the corresponding letter delivery enterprise is kept as low as possible, presorting into the corresponding transport baskets is already carried out by the abovementioned persons. As has already been mentioned, this takes place according to corresponding criteria. Here, these criteria can be related, in particular, to the address information, with the result that, for example, presorting according to zip code regions can already take place. This sorting can be designed to be differentiated in various ways, with the result that even very precise sorting can take place, depending on the amount of letters.

In order for it to be possible to perform the division into, for example, corresponding zip code regions, the persons which perform the sorting act in the simplest case in such a way that they read the corresponding zip codes on the letters which have been placed into envelopes. In order to facilitate this very laborious and wearisome work, corresponding markings are frequently inserted in the address field of the letters depending on the zip code regions. These markings can then either help the corresponding sorting person to detect different zip code regions more quickly, or can be configured in such a way that they are detected electronically by a scanner. The latter then ensures by way of a separate unit that, for example, the letters are transported in the continuous stream with a slight offset on the belt, at which a transition occurs from one zip code region to the next. This offset can then be detected readily by the sorting persons, with the result that, for example they only need to pick up the letters between one offset and the next, without having to concentrate further on the respective address fields. In addition to the separate markings, a scanner of this type can of course also read the zip codes directly by character recognition.

Even though this method has already been established for years, it has some faults and fault sources which can be eliminated with difficulty, in particular in the case of the method approach described above. It is therefore understandable that errors are frequently made by the corresponding sorting persons, by regions being picked up incorrectly, being detected incorrectly and, as a result, being sorted into the transport containers incorrectly. This then leads to increased outlay in the letter delivery enterprises, which is associated either with delays or else with higher costs for the dispatching enterprise. In addition to the error rate which is introduced into the system by the corresponding sorting persons, a constant cost outlay is also associated with these letter deliveries as a result of this necessary sorting staff.

Transporting and sorting operations of this type can also be necessary for other flat products such as cartons, blanks, folding boxes, plates, dividing plates, for example made from plastic, paper, cardboard or metal, if they are delivered in relatively large numbers from a preliminary station, but are to be processed further in different packet sizes.

All flat products of this type have side edges which lie opposite one another, as viewed over their surface. Here, they do not necessarily have to run in a straight line, but rather can also be curved. In either case, all flat products of this type are having a plane characterized by their largest extension.

It is therefore an object of the present invention to develop a transport device to the extent that the flat products can be gripped in such a way that they can be transported individually or in groups. For this purpose, a novel method and a corresponding device for carrying out this method should be provided.

### SUMMARY OF THE INVENTION

This object is achieved firstly by a device for transporting flat products extending in a plane, comprising a first transport unit, transporting said flat products in a transport direction, and at least one feeder feeding said flat products to said first transport unit, said first transport unit comprising at least two first transport elements, said first transport elements being arranged parallel to said transport direction, said flat products comprising side edges lying opposite to one another, wherein said first transport elements can be set against said opposite side edges thereby gripping and separately holding said flat products and transporting said flat products with their plane being upright with respect to said transport direction.

This device which is configured in this way allows the corresponding flat products which as a rule come horizontally or lying down, for example, from an enveloping machine, after being transferred into an upright position, that is to say substantially perpendicularly with respect to the following transport direction, to be received and to be transported in a row one after another. This perpendicular or upright alignment of the flat products already corresponds to the arrangement, in which the products are also received into a corresponding transport container.

Holding at side edges which lie opposite one another, that is to say, as viewed in the transport direction, at the right-hand and left-hand edge of the flat products, has the advantage that the flat products are then held on the sides which lie opposite one another, in such a way that they cannot readily change their position with respect to one another. In other words, each flat product is held separately. As a result, inter alia, a uniform spacing from one flat product to the next can be ensured. This spacing can be chosen as one prefers with the thickness of the flat products as the only boundary.

This is advantageous, in particular, if either all the products or only individual ones are of somewhat thicker configuration. This thickness can be brought about, for example, by simply a higher sheet number for the respective mail item, or else can also occur during the dispatch of brochures which as a rule have a thicker folded edge.

A non-uniformity, present in this way, of the flat products to be transported has previously led to a stack being thicker on one side, for example the lower edge than on the opposite side, for example the upper edge, as a result of the products being built up heavily on one side. This non-uniformity can then readily lead to this stack tilting, slipping or else sliding away from the sorter who wants to pick up the stack, which messes up the entire sorting operation.

Holding at the side edges which lie opposite one another prevents this by virtue of the fact that the usual holding together between the frontmost and the rearmost product, as viewed in the transport direction, does not take place, but rather each flat product is held separately. As a result of the variability of the transport elements, a respective spacing of the products from one another depending on their thickness and their individual configuration is even possible.

As a consequence, the entire stack of flat products which is transported within the transport unit has flat products which are arranged parallel to one another and are oriented individually.

The contact pressure of the transport elements which are set against the side edges which lie opposite one another is to be selected in such a way that the flat products do not slip out, whether on account of gravity or other factors such as an insufficient flexural rigidity of the products. For this and for the sake of avoiding damages to the flat products the contact pressure should at the same time not be too high in order to avoid unwanted buckles or breaking of the flat products.

Relatively heavy products have to have a correspondingly high flexural rigidity, in order not to buckle and as a result to slip out, since the contact pressure has to be correspondingly higher in the case of heavy products.

The contact against the side edges which lie opposite one another can also take place in a punctiform manner, with the result that, for example, a round flat product such as a disc or a plate can be held between the transport elements.

The action on side edges which lie opposite one another and not on the upper or lower edge has the advantage that, for example, a downward discharge with the aid of gravity is not impeded by the transport elements.

In a further embodiment of the invention, the device has at least one second transport unit which has at least one second transport element, by which the products can be transported further in the transport direction and can be released from the device, the at least one second transport element being arranged parallel to the transport direction and it being possible for the said at least one second transport element to be set against at least one edge of the flat products, with the result that the flat products can be gripped and separately held by the at least one transport element and can be transported with their plane being upright with respect to the transport direction.

This measure has the advantage that a continuous operation of the device is made possible in a simple way by this division of this device into a first and a second transport unit. This is due to the fact that the first transport unit can be responsible, for example, for sorting, while the second transport unit which can be actuated separately from it can be configured, for example, for transferring the flat products into a transport container, i.e. removing the flat products from the device. This is advantageous, in particular, in relation to the last point, since a change during operation made on the second transport unit which is performed for transferring the flat products into a transport container has no effects on the transport and the flat products in the first transport unit. After sorting, the flat products can then be transferred by a correspondingly configured continuous transfer into the second transport unit, from where the above-described transition into the transport containers can take place.

Although a first and a second transport unit in the sense of two separate units were mentioned before and will be mentioned in the following, this is to be understood, however, as both structurally separate units and also structurally combined transport units. This designation is merely intended to make reference to the fact that an overall transport section which the device has can be divided into two separately actuable transport units. It is therefore conceivable in the scope of the present invention that the respective transport elements of the first and second transport units are separate elements, but also that these transport elements have an overall transport element which is divided into different individual sections according to the explanations made above.

In a further embodiment of the invention, the second transport unit has two transport elements which can have their distance from one another varied perpendicularly with respect to the transport direction.

This measure has the advantage that the flat products can first of all be accepted continuously by the two first transport elements of the first transport unit. The variability of the distance of the second transport elements of the second transport unit from one another has the advantage that the flat products which are transported in this second transport unit are held at side edges which lie opposite one another, as in the first transport unit. If the second transport elements are moved apart, the products can be brought out of their holding engagement with them in a simple way. In principle, the flat products are therefore removed from the device by a change in the distance, namely moving apart of the two second transport elements of the second transport unit perpendicularly with respect to the transport direction. As a result, the flat products can then be transferred into the corresponding transport containers either on account of gravity or by a separate mechanism.

In a further embodiment of the invention, at least the first transport elements of the first transport unit each have at least one transport belt, onto which the side edges of the flat products can be set and by which they can be gripped.

This measure has the advantage that transport belts permit continuous transport operation in a simple way. As a result, it becomes possible to transport the flat products in a variable manner, that is to say at any desired spacing from one another, since there are no separate and predefined receptacles for the respective flat products, which receptacles define the positions of the individual products along the transport element. At the same time, this measure also allows that each product can be held separately or individually. The products can therefore be arranged independently of one another between the respective transport elements. It is accordingly irrelevant for the arrangement of a respective flat product how many flat products are arranged in front of it in the transport direction and how many follow it.

Friction-assisting holding or acting on the flat products can take place with as low a contact pressure as possible by selection of a corresponding coating of the transport belt, for example with a foam or bumps. This assists in a safe grip of the flat products in that the flat products are neither subject to buckles or breaks nor to falling out of the device. A further advantage of transport belts comprises the fact that the transfer from the first transport unit into the second transport unit can accordingly take place continuously. This is possible, for example, as a result of transport belts which are offset with respect to one another in terms of height but which overlap in the transport direction. An arrangement is also conceivable, in which the first and second transport units in each case have a continuous transport element, that is to say a continuous transport belt. This can be divided, for example, by corresponding deflecting rollers which are arranged along the extent of the transport belt in the transport direction.

In a further embodiment of the invention, the transport units in each case or together have at least one further transport element which can be set against further edges, in particular against the lower edges of the flat products.

This measure has the advantage that in addition to being held at their side edges, the flat products can be held or supported in addition, for example, at the lower edge in a desired region of the transport device. This is advantageous, in particular, in the case of very wide or extremely heavy flat products. This measure is also advantageous in the case of lightweight products if there is a high transport speed, at which it has been shown that the flat products can tend to vibrate. This is reduced by way of the further transport element which can be set against the lower edge of the flat products. If transport belts with products held between them are accelerated, tilting movements can take place on account of the inertial mass, in particular in the case of asymmetrical products, which tilting movements can thus be avoided.

Even though a transport element which can be set against the lower edge was mentioned before, transport elements which can be set against the upper edge or against the upper edge and against the lower edge of the flat products are also conceivable in the scope of this invention.

The additional arrangement of a further transport element which can be set against the lower edge is advantageous, in particular, for the first transport unit, but can also partially extend exclusively into the second transport unit, can extend completely in the latter or can lie merely in the region of this second transport unit, depending on which direction the products are to be deposited in.

In a further embodiment of the invention, furthermore, the device has a pusher which is arranged such that it can be moved at least perpendicularly with respect to the transport direction and such that it can be moved against an upper edge of the flat products.

This measure has the advantage that the flat products can be transferred by a pusher of this type into the corresponding transport containers. This preferably takes place after a sorting operation. Furthermore, this pusher is preferably arranged in the region of the second transport unit, if present. Here, the pusher can transfer the flat products to be transferred solely by a movement in the direction of gravity, that is to say from top to bottom, into the transport containers or else can also interact with the preferred embodiment of the transport elements of the second transport unit, which transport elements can have their spacing from one another varied. Thus, temporally coordinated interaction can achieve a situation where the flat products are transferred as one contiguous packet into the transport container, instead of simply only falling due to gravity out of the transport elements of the second transport unit which are moving apart from each other. As a result of the last variant, mixing up or canting can occur because of tilting of the flat products in or at the transport container.

In a further embodiment of the invention, the pusher is arranged such that it can be moved additionally in the transport direction.

This measure has the advantage that, instead of simply carrying out only a perpendicular movement, the pusher can additionally be driven with the flat products in the transport direction. As a result, firstly an even more continuous transition of the flat products into the transport container is made possible. Secondly, in the case of a preferably present stop element which is arranged at the end of the transport container as viewed in the transport direction, pushing together or even compression of the flat products can thus be achieved before they are transferred perpendicularly downwards into the transport container.

In a further embodiment of the invention, the device has a control unit, by which at least the transport units can be controlled.

As a result of a control operation of the transport units, both the operation of sorting and the transfer of the flat products into the transport container are made possible in a coordinated manner. Furthermore, as a result of this, the feeding of the flat products into the first transport unit, the transition of the flat products from the first into the second transport unit and varying of the transport elements of the second transport unit and the actuation of the pusher for transferring the flat products into the transport containers are also preferably controlled. Moreover, a control operation of the transport containers, preferably their exchange, can also be carried out by the control unit.

In a further embodiment of the invention, the control unit is designed to receive data from the feeder or from a second unit which is positioned in front of the feeder or is connected to it, and to divide the products into separate groups of products in the device on the basis of these data, which groups are separated from one another by spacings along the transport direction.

This measure has the advantage that the device according to the invention can thus automatically carry out the steps which were previously carried out by a sorting person mentioned at the outset, optionally in interaction with marking by a separate machine with scanner.

By way of a scanner or a camera, the control unit is thus capable of receiving data from either the enveloping machine, the feeder, a unit which is present between the enveloping machine and the feeder, or from the device itself, and of forwarding corresponding control commands to the transport units on the basis of these data. To this end, these data can either already be processed accordingly or can be evaluated by the control unit itself.

In order to sort the products within the first transport unit, there is provision according to the invention for this purpose for the products to be divided into separate groups. This can take place simply by variation of the transport speed. If, for example, a desired number of products are received one after another, the transport speed can be increased briefly, with the result that a spacing from the next following product is produced. As a result, packets of flat products are always produced which can be transported further within the device and finally can be transferred into a respective transport container.

The division into groups with spacings or intermediate spaces arranged between them has the advantage, furthermore, that simultaneous transport of a plurality of groups or packets is thus possible in the transport direction within the first transport unit, while only a single such packet can be present in the second transport unit. This can then be transferred into a respective transport container by corresponding above-described changes to the second transport unit independently of the packets and groups in the first transport unit. This preferably takes place by way of an above-described pusher.

Furthermore, the object of the present invention is achieved by a method for transporting flat products extending in a plane in a transport direction, said flat products comprising side edges lying opposite one another, said method comprising the following steps: receiving of said flat products from a feeder into at least one first transport unit, said first transport unit having at least two first transport elements, transporting of said flat products within said first transport unit in said transport direction, wherein said flat products are separately held and gripped by said first transport elements at said side edges and are transported with their plane being upright with respect to said transport direction.

The advantages in relation to this method can be derived in an analogous manner from the previously made comments in conjunction with the device.

Here, however, the advantageous transport in an orientation wherein said flat products are transported with their plane being upright with respect to said transport direction is to be emphasized once again, with the result that they already assume the orientation during transport which they also have to have later in the transport container. This considerably simplifies the transfer into transport containers and therefore the entire sorting operation.

In an embodiment of the invention the flat products are envelopes.

In a further embodiment of the method according to the invention, the flat products are fed individually or in small packets, and the flat products are transported in the transport unit such that they are arranged parallel to one another and, as viewed in the transport direction, behind one another at any desired spacing from one another.

This measure has the advantage that, with reference to the embodiments which are described in conjunction with the device, the flat products can already be transported individually or in small packets in such a way that, in this arrangement, they can be transferred simply into a corresponding transport container. This is the case as a result of the arrangement of the flat products which are parallel to each other and behind one another, as viewed in the transport direction. This is due to the fact that the transport containers are as a rule configured in such a way that the corresponding flat products in the transport containers have precisely an arrangement of this type. The provision of transporting at any desired spacing from one another has the advantage that, during transport in the at least one transport unit, the flat products can still be arranged uniformly and parallel to one another between the transport elements, independently of whether they optionally contain products which are built up heavily on one side. This means that, for example, independently of whether envelopes with in each case only one sheet or envelopes with a plurality of sheets or brochures with a thick folded edge are arranged within the envelope, a spacing can always accordingly be selected as desired, with the result that, in particular, the criteria can be satisfied in parallel and behind one another.

In the context of the present invention, the reference to small packets means that small stacks of, for example, up to 15 flat products can also be fed at once to the transport device and are correspondingly transported in the latter. This goes without saying, without being mentioned separately, for all preceding descriptions and all those which are still to follow, in which in each case usually only one single flat product is mentioned.

In a further embodiment of the method of the invention, this method has the following further step:

dividing of the flat products which are fed in into separate groups of flat products within the first transport unit, by introducing spacings along the transport direction.

This measure has the advantage which has also previously been described in conjunction with the device that a division of the flat products into individual groups or packets can take place on the basis of corresponding information, such as zip code regions. This preferably takes place by the introduction of spacings or intermediate spaces along the transport direction within the first transport unit, with the result that one group can always be sorted separately into the corresponding transport containers.

In a further embodiment of the method of the invention, the introduction of the spacings comprises a brief increase in the transport speed of the first transport elements between the receiving of two flat products from the feeder.

This embodiment represents a preferred type of how the division within the first transport unit can take place.

The increase in the transport speed provides a simple possibility of division which does not require any further constructive measures apart from corresponding measures with respect to the control operation of the device. In terms of the method, this step would then take place in such a way that the flat products, which have already been received in the first and second transport units and as a rule are in each case always transported forwards with a small advance in the transport direction when a new flat product is received from the feeder, are moved away clearly in the transport direction from a new flat product before the latter is received. Here, this rapid advance leads to a spacing of preferably several centimetres. This allows there also to be a sufficient spacing, in order to sort the flat products which have correspondingly been received previously into the device out of the at least one transport unit into corresponding transport containers without impairing the following flat products.

In a further embodiment of the method of the invention, this method has the following further steps:

continuous transferring of the flat products from the first transport unit into at least one second transport unit which has at least one second transport element,

further transporting of the flat products within the second transport unit in the transport direction, wherein the flat products are held by the second transport element at least at one edge and are transported with their plane being upright with respect to said transport direction.

This measure has the advantages which have already been described above in conjunction with the second transport unit of the device.

Furthermore, the continuous transferring of the flat products has the advantage that no separate stopping and transferring of the flat products into the second transport unit or, for example, a transport container is necessary. As a result of the separate transport units, as has already been explained above, a division is possible such that both feeding of the flat products into the transport units and sorting of the flat products into transport containers can take place, preferably after division into groups has taken place, without these two processes being disrupted or impaired.

In a further embodiment of the method of the invention, this method has the following further step:

removing of the flat products from the second transport unit and transferring of the flat products into a transport container.

This method step represents the concluding step in the preferred embodiment of the present invention. In this step, the flat products, sorted correspondingly into groups, have passed into the second transport unit and are then sorted into corresponding transport containers for further processing or for forwarding, for example, to the letter delivery enterprise.

It will be appreciated that the aforementioned features and the features still to be explained below can be used not only in the respectively specified combination, but also in other combinations or alone, without departing from the scope of the present invention.

### BRIEF DESCRIPTION OF THE DRAWINGS

The invention is described and explained in more detail below on the basis of a number of selected exemplary embodiments and with reference to the attached drawings, in which:

FIG. 1 shows a side view of a device according to the invention,

FIGS. 1a and 1b show a diagrammatic illustration of a flat product,

FIG. 2 shows a plan view of details of the feeder and transport units of the device from FIG. 1,

FIG. 3 shows details of a sectional view of the illustration of FIG. 2,

FIGS. 4a to 4c show a step-by-step diagrammatic illustration of the transfer of a group of flat products into a transport container from a transport unit in the case of a continuously diagonal movement of a pusher,

FIGS. 5a to 5d show an illustration corresponding to FIGS. 4a to 4c with a transfer of the flat products into a corresponding transport container as a result of a perpendicular movement of the pusher,

FIG. 6 shows an device corresponding to FIG. 1 with a control unit which is additionally shown diagrammatically here, and

FIGS. 7a to 7f show a diagrammatic illustration of the sequence of the division of flat products into individual groups or packets in a plan view, to two associated first transport elements of the first transport unit, comparable with an illustration of FIG. 2.

### DETAILED DESCRIPTION OF PREFERRED EMBODIMENTS

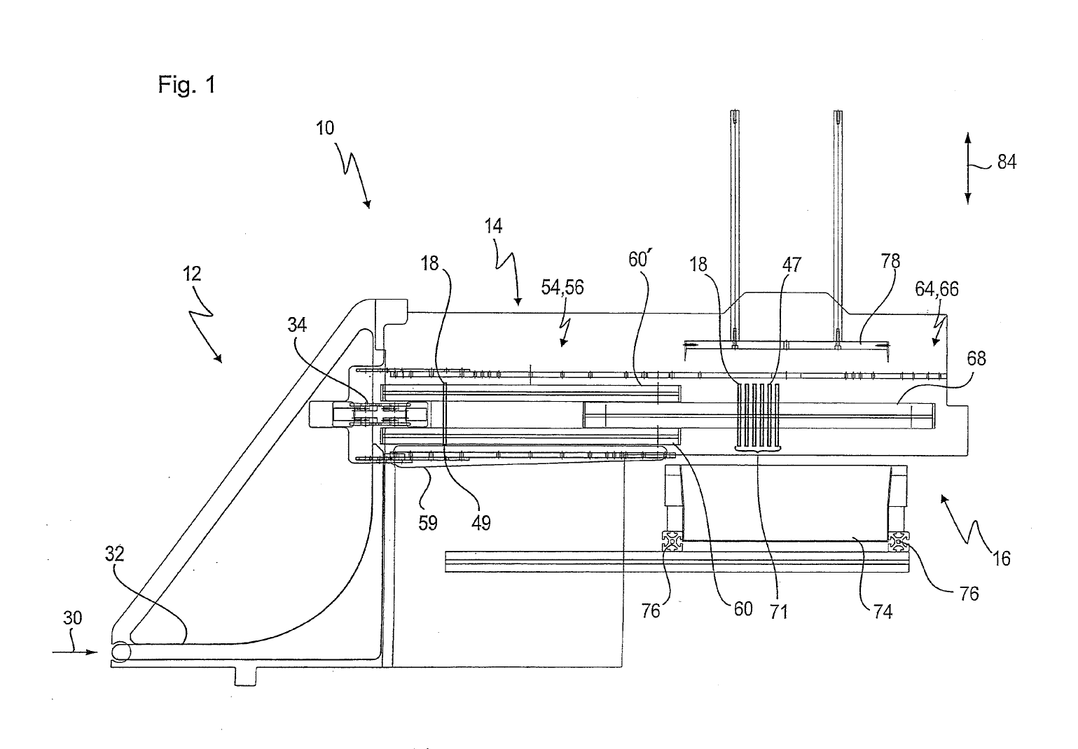

A device according to the invention which is shown in FIGS. 1 to 7f is designated by the reference numeral 10.

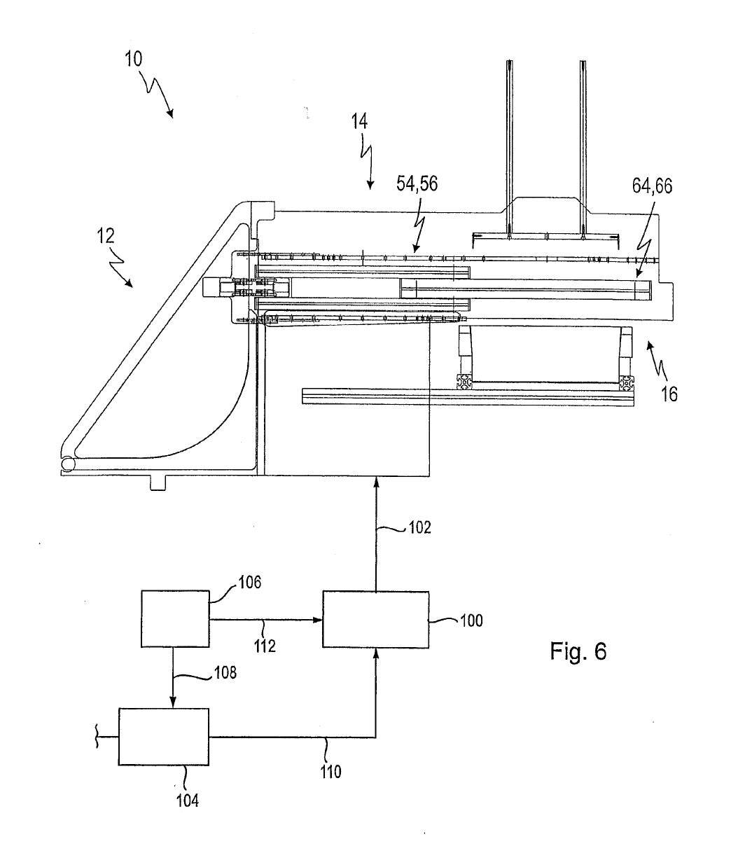

This device 10 has a feeder 12, a first transport unit 14 and a second transport unit 16. This can be gathered, in particular, from the illustrations of FIG. 1 and FIG. 6.

The feeder 12 receives flat products 18 in the form of envelopes, as will be described in greater detail, in particular, in conjunction with the following figures, from an enveloping machine (not shown). The said enveloping machine serves substantially to transfer machine-printed letters into envelopes and to close the latter, and discharges them subsequently as a rule lying horizontally on a transport belt, according to the illustration of FIG. 1. They thus pass into the feeder 12 in accordance with a feed direction which is shown there by an arrow 30.

Furthermore, the feeder 12 has a transport belt 32. The said transport belt 32 receives the flat products 18 from the feed direction 30 and moves them into an upright oriented position, meaning that their plane is upright with respect to a following transport direction 52, in accordance with its bent course which can be seen in FIG. 1. They are received there by a linear conveying device 34.

The said linear conveying device 34 is likewise a constituent part of the feeder 12. The linear conveying device 34 ensures that the flat products 18 which are now upright are transferred to the first transport unit 14. In accordance with the illustration of FIG. 1, the flat products 18 are preferably perpendicularly upright here.

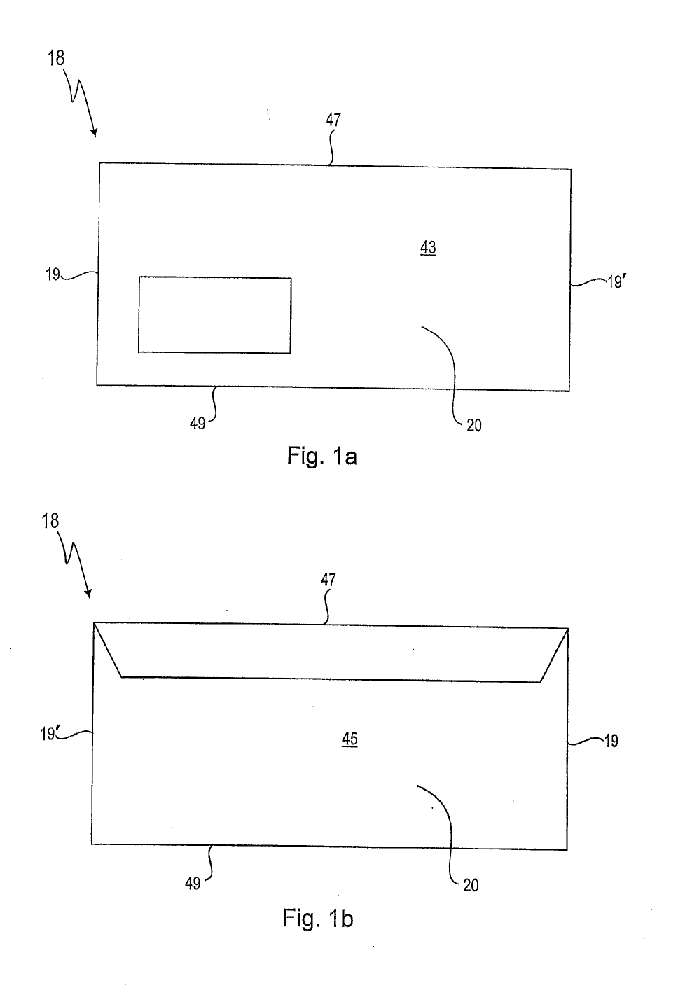

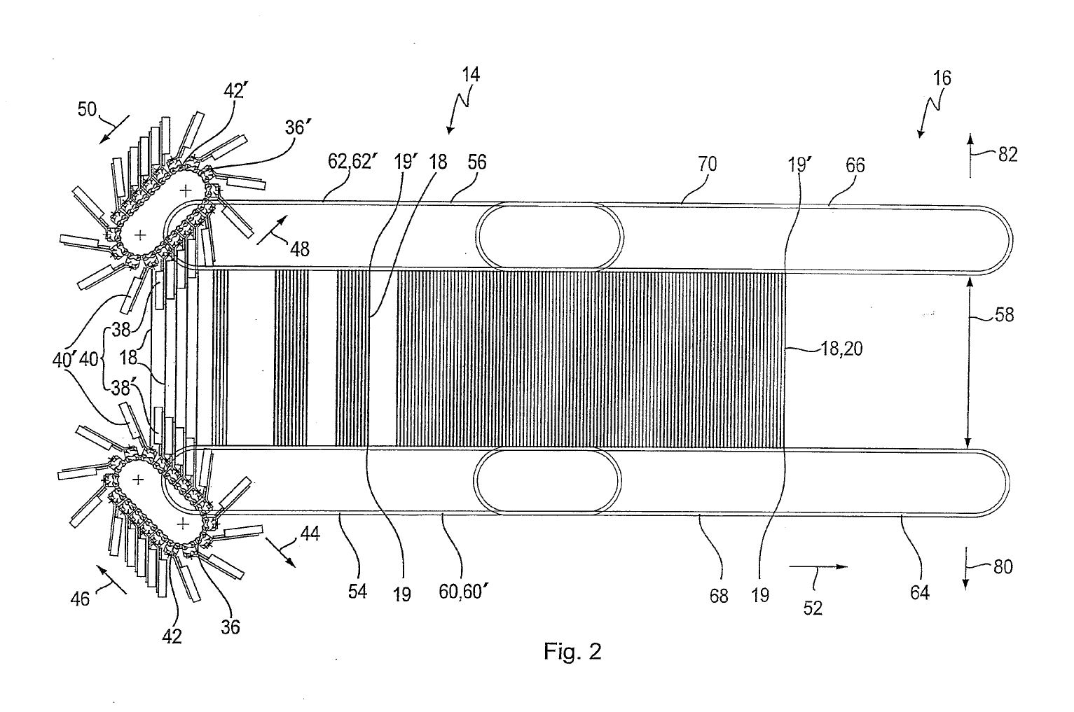

It can be seen, in particular, from FIGS. 2 and 3 how this transfer from the linear conveying device 34 into the first transport unit 14 takes place.

It can be seen here in conjunction with FIG. 2 that the linear conveying device 34 has two conveying units 36 and 36′.

The said conveying units 36 and 36′ themselves have in each case guiding elements 38, two guiding elements 38 and 38′ which lie opposite one another forming a guiding-element pair 40.

The flat products 18 which, according to the illustration of FIG. 2, move in the direction towards the observer are then received between two adjacent guiding-element pairs 40 and 40′ and are held between the latter.

The guiding elements 38 are in each case arranged on a chain 42 and 42′. This respective chain 42 runs through a respective movement which is indicated with the aid of arrows 44, 46 and 48, 50. This movement leads to the guiding elements 38, from receiving a flat product 18, moving together with the latter in a transport direction 52.

As a result, the flat products are moved gradually by the linear conveying device 34 in the transport direction 52 towards the first transport unit 14. Finally, as a result, they are also introduced into the transport unit 14 and are accommodated in the latter.

FIGS. 1a and 1b show an exemplary flat product 18. In this exemplary embodiment, the said flat product 18 is an envelope 20. The latter has a front side 43 and a rear side 45. Furthermore, it has an upper edge 47 and a lower edge 49 and side edges 19 and 19′. The front side 43 and rear side 45 are basically forming the plane of this flat product 18.

It goes without saying that these designations are primarily to be understood as relative specifications in relation to the usual use and the usual operation of a device according to the invention and the associated orientation of the flat products 18. Orientation-independent commitment to the designations shown for the envelope 20 is not desired here, but rather a corresponding adaptation of the designations is to be performed if, for example, the envelope 20 is present in the device with an orientation turned by 180°. Thus, for example, the upper edge shown here would then become the lower edge and vice versa.

If, however, envelopes 20 are spoken of before and in the following, it goes without saying that the comments in relation to this designation also always apply to general flat products 18, as long as nothing else is stated.

The first transport unit 14 has two first transport elements 54 and 56. They are oriented parallel to one another. Furthermore, they are also oriented parallel to the transport direction 52. They are at such a distance 58 from one another that a flat product 18 can be received between them such that it can be placed with its side edges 19 and 19′ against the first transport elements 54 and 56.

In this exemplary embodiment, in addition, the first transport unit 14 also has a further transport element 59 which is arranged in such a way that it can be placed against the lower edges 49 of the flat products 18. This transport element 59 can be seen, in particular, in FIGS. 1 and 3. It additionally supports the flat products 18 or envelopes 20 during transport and therefore reduces possible vibrations which can occur, in particular, during rapid transport or rapid advancing. Furthermore, it also prevents flat products 18 which are possibly not held correctly from being able to fall out downwards. Moreover, it also assists the transition from the first transport unit 14 into the second transport unit 16.

In the present exemplary embodiment, the first transport elements 54 and 56 in each case have two transport belts 60, 60′ and 62, 62′. Independently of the embodiment which is shown, it is also conceivable within the scope of the present invention that a respective first transport element 54, 56 can be equipped with either a transport belt or else with more than two transport belts.

In order that the flat products 18, in particular envelopes 20, after setting on of the first transport elements 54 and 56 or of the transport belts 60 to 62′, can be held by the latter in a loadbearing manner, the transport belts 60 to 62′ have holding materials on their surface in one preferred embodiment or are manufactured from materials of this type. These materials can be, for example, foam-like materials, such as polyurethane foams, or else can also be present as belts which are configured with pimples. Foam-like materials have the advantage that they can compensate the contact pressure resulting from the first transport elements 54, 56 pressing against the side edges 19, 19′ of the flat products 18. This way a strong enough clamp, hold and grip can be achieved while simultaneously avoiding breaks or buckles as a result of a pressure which is too high.

In accordance with the comments made above, the flat products 18 or envelopes 20 are moved onto the first transport elements 54 and 56 of the first transport unit 14 and are held in a loadbearing manner by slight lateral clamping. This clamping takes place by a contact pressure of the first transport elements 54 and 56 during setting against the side edges 19 and 19′ of a flat product 18 or envelope 20.

If, in the preceding or following, the side edges 19 and 19′ of a flat product 18 or envelope 20 are spoken of, the right-hand and left-hand side edges of a flat product 18 of this type are meant, which side edges are present in relation to the upright transport of the flat products 18 in the present device 10, as has already been explained in conjunction with FIGS. 1a and 1b.

The envelope 20 which is received in this way in the first transport unit 14 between the first transport elements 54 and 56 is then moved in the direction 52 by continuous or stepped transport of the first transport elements 54 and 56. This transport or this movement of the first transport elements 54 and 56 preferably takes place here synchronously with the feeder 12 or is coordinated with the latter.

Moreover, a division of the envelopes 20 into groups or separate packets can take place, however, by an at least brief separate actuation of the first transport elements 54 and 56 with respect to the feeder 12, as will be described in even greater detail in the following.

After running through the first transport unit 14, the envelopes pass into the second transport unit 16.

The second transport unit 16 likewise has two second transport elements 64 and 66. These two second transport elements 64 and 66 are likewise arranged parallel to one another. Furthermore, these second transport elements 64 and 66 are also arranged parallel to the transport direction 52. In the present exemplary embodiment, the second transport elements 64 and 66 in each case have a transport belt 68 and 70.

Independently of the present exemplary embodiment, it is also conceivable here that the second transport elements 64 and 66 of the second transport unit 16 can likewise in each case have two or else more transport belts.

In the exemplary embodiments which are shown in the figures and in which the flat products 18 or the envelopes 20 are held on opposite sides in the second transport unit 16, an embodiment is also conceivable, in which the arrangement of the flat products 18 or envelopes 20 takes place on only one side on a transport element. This side can be, for example, the upper edge 47 of an envelope 20 or of a flat product 18, with the result that the products 18 or envelopes 20 can be transported in a correspondingly hanging manner along the transport direction 52. Furthermore, it is conceivable in an arrangement of this type, but also in the arrangements described above, that, in particular, the further transport within the second transport unit 16 takes place in a manner which deviates from the actual transport direction 52.

The envelopes 20 which are then preferably situated in a group 71 of envelopes 20 within the second transport unit 16 and are separated here from the other envelopes 20 within the first transport unit 14 are next transferred into a transport container 74. This transport container 74 serves to transfer the corresponding envelopes 20 to any desired letter delivery enterprise.

The transport container 74 can be seen, in particular, in FIG. 1. It can be seen there that the said transport container 74 is arranged below the second transport unit 16 according to the illustration of FIG. 1.

Here, it is arranged displaceably, for example, on rails 76 which extend perpendicularly with respect to the plane of the drawing of FIG. 1, with the result that any desired exchange of the transport container 74 for further transport containers can take place here. This exchange can also take place in an automated manner. Furthermore, in addition to an arrangement on rails 76, an arrangement (not shown) on, for example, transport belts or other means which are commonly known to a person skilled in the art is also conceivable.

Furthermore, a pusher 78 is also arranged in the region of the second transport unit 16. According to the illustration of FIG. 1, this pusher 78 is arranged above the second transport unit 16 and is therefore situated on the opposite side of the transport container 74.

The transfer of the group 71 of envelopes 20 from the second transport unit 16 into the transport container 74 can take place in different ways.

Here, simply bringing the second transport elements 64 and 66 out of contact with the envelopes 20 of the group 71 could be mentioned as a simple variant in terms of the sequence.

To this end, the second transport elements 64 and 66 are arranged variably at a distance from one another perpendicularly with respect to the transport direction 52. This can be seen, for example, in conjunction with the illustration of FIG. 2. Here, an arrow 80 for the second transport element 64 and an arrow 82 for the second transport element 66 indicate the respective movements which they carry out, in order to release the group 71 of envelopes 20.

After a release of this type, these envelopes 20 of the group 71 fall perpendicularly downwards on account of gravity into the transport container 74 which is situated below them, according to the illustration of FIG. 1.

Since, however, mixing up and canting of the envelopes 20 can occur as a function of the size of the group 71 of envelopes 20, the pusher 78 can be used in addition to allowing them to fall.

The pusher 78 is arranged in such a way that it can be moved perpendicularly with respect to the transport direction. This movability is indicated by the double arrow 84 in the illustration of FIG. 1.

In order then to transfer the group 71 of envelopes 20 into the transport container 74 in the form, in which the said group 71 is present in the second transport unit 16, the pusher 78 is moved downwards towards the said group 71 according to the illustration of FIG. 1 and therefore forms an element which can be set against the upper edge 47 of the envelopes 20 of the group 71. Here, the pusher 78 presses on the envelopes 20 of the group 71 substantially from the moment, from which the second transport elements 64 and 66 release the said envelopes 20. The further movement of the pusher 78 downwards according to the illustration of FIG. 1 then takes place in such a way that the said pusher 78 accelerates the corresponding envelopes 20 at least slightly more rapidly than would happen as a result of gravitational acceleration. This achieves a situation where no indiscriminate turning or canting of the individual envelopes 20 within the group 71 can occur as a result of the abutment which the pusher 78 forms.

In an alternative embodiment, the pusher 78 brings the upper edge 47 of the envelopes 20 of the group 71 out of the holding engagement with the second transport elements 64 and 66 solely as a result of the contact pressure of the said pusher 78 against the said upper edge 47. This means that, in an embodiment of this type, no lateral spacing of the second transport elements 64 and 66 from one another is required, as has previously been indicated in conjunction with the illustration of FIG. 2 by the arrows 80 and 82.

After the group 71 of the envelopes 20 has then been arranged in the transport container 74, the latter can be replaced by a further transport container 74′ (not shown), into which then a new group 71′ of envelopes 20 can be introduced.

In addition to the displaceable arrangement of the pusher 78 shown in conjunction with FIG. 1 according to the double arrow 84, it is also conceivable that this pusher 78 can additionally run through a movement in the direction of the transport direction 52.

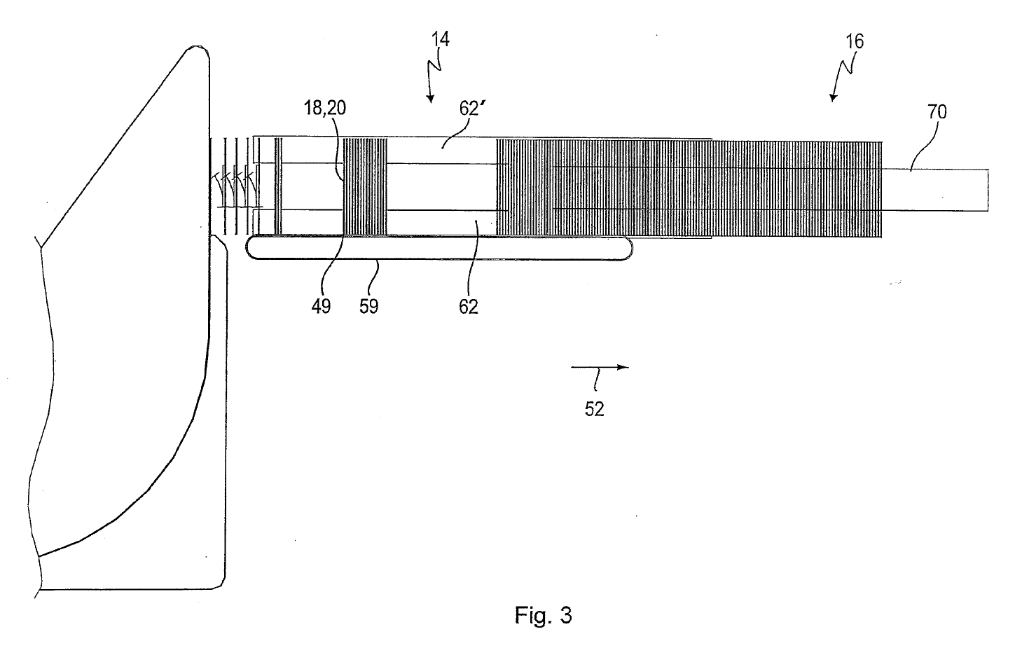

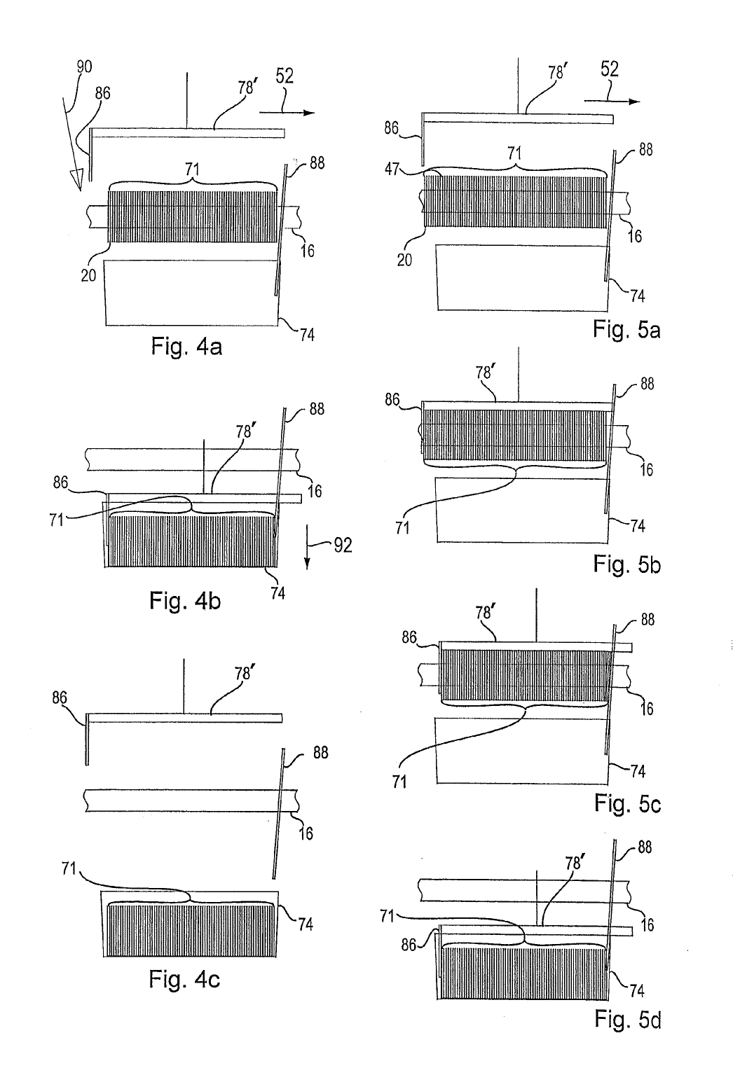

This results in preferred exemplary embodiments for transfer of a group 71 of envelopes 20 into a transport container 74, as are shown in conjunction with FIGS. 4a to 4c and 5a to 5d.

FIGS. 4a to 4c show one embodiment of a transfer method, in which the pusher runs through a diagonal movement. In contrast to the pusher 78 of FIG. 1, the pusher 78′ which is shown here has a stop 86. According to the illustration of FIGS. 4a to 4c and also 5a to 5d, this stop 86 is arranged at the rear end of the pusher 78′ as viewed in the transport direction 52.

In addition, the device 10 in these exemplary embodiments of FIGS. 4a to 5d also has a stop 88. This stop 88 is arranged in such a way that, as viewed in the transport direction, it is arranged at the front and at the end of the second transport unit 16. Here, it protrudes at least temporarily into the transport container 74. Furthermore, it is arranged in such a way that the envelopes 20 which are transported in the second transport unit 16 can ultimately come into contact with this stop 88 during continuing transport.

In the illustration of FIGS. 4a to 4c, the pusher 78′ which is present in this embodiment is at the same time moved in accordance with the direction of the double arrow 84 and in the direction of the transport direction 52. This results in an oblique or diagonal movement in accordance with the direction of the arrow 90.

The group 71 of envelopes 20 can thus be transferred into the transport container 74 in a continuous oblique movement of the pusher 78′. To this end, first of all the stop 86 comes into contact with the rear envelopes at first, as viewed in the transport direction 52. Here, this stop 86 has a slight contact pressure against this group 71 in the transport direction 52 as a result of the further movement. As soon as the group 71 of envelopes 20 is then released from the second transport elements 64 and 66 in accordance with the comments made above, the further movement of the pusher 78′ in the direction of the arrow 90 takes place at the same time, it being additionally possible for the group 71 of envelopes 20 to be pressed against the stop 88. This group 71 can therefore be compressed further a little and ultimately can be transferred with an accurate fit into the transport container 74.

The exchange of the transport container 74 which is then filled takes place, for example, by the stop 88 moving out and then being moved laterally in accordance with the illustration of FIG. 1 and the previously stated description. As an alternative, an exchange can also take place by lowering of the transport container 74 in accordance with the illustration of FIGS. 4b and 4c, the said transport container 74 then being moved downwards in accordance with the direction of the arrow 92. Following this, movement in the direction of the observer can then take place again, as has been explained in conjunction with the transport container 74 of FIG. 1.

In accordance with the illustration of FIGS. 5a to 5d, transfer of the group 71 of envelopes 20 is also conceivable in a sequential movement of the pusher 78′.

To this end, in accordance with the illustration of FIG. 5a to FIG. 5b, the pusher 78′ is first of all moved with its stop 86 perpendicularly onto the group 71 of envelopes 20. Here, the pusher 78′ is set against the upper edge 47 of the envelopes 20. Next, the pusher 78′, as is shown in conjunction with FIGS. 5b and 5c, can be moved in the transport direction 52. Here, the envelopes 20 of the group 71 are pushed against the stop 88. This preferably takes place after the holding contact between the second transport elements 64 and 66 and the envelopes 20 of the group 71 has been cancelled, as has already been described in greater detail before.

After the envelopes 20 have then been pressed against the stop 88 and are therefore held between the stop 88 and the stop 86 of the pusher 78′, the pusher, as can be seen in the transition from FIG. 5c to FIG. 5d, can be moved downwards in a perpendicular movement, as is indicated by way of a double arrow 84. Here, the envelopes 20 of the group 71 are driven and transferred into the transport box 74.

This above-described method of FIGS. 5a to 5d is also very suitable, in particular, for the case where the length of the group 71 of the envelopes 20 exceeds that of the transport container 74. This lies in the fact that the envelopes 20 are additionally compressed in the transport direction 52 during the step in the transition from FIG. 5b to FIG. 5c.

In accordance with the illustration of FIG. 5a in the transition to FIG. 5b, it is possible, furthermore, that a division of envelopes 20 which are arranged in a row within a transport unit 14, 16 can also be carried out in groups by this method. To this end, the stop 86 is moved in a perpendicular movement in accordance with the double arrow 84 between two envelopes 20, between which the division is to take place. This method is therefore also suitable for devices which have, for example, only one transport unit 14, 16 or generally have no division into groups 71, as will be described in greater detail in the following.

In accordance with the illustration of FIG. 6, the device 10 in this embodiment additionally also has a control unit 100.

This control unit 100 serves to control, in particular, the transport units 14 and 16, but preferably also the entire device 10. This is indicated by an arrow 102.

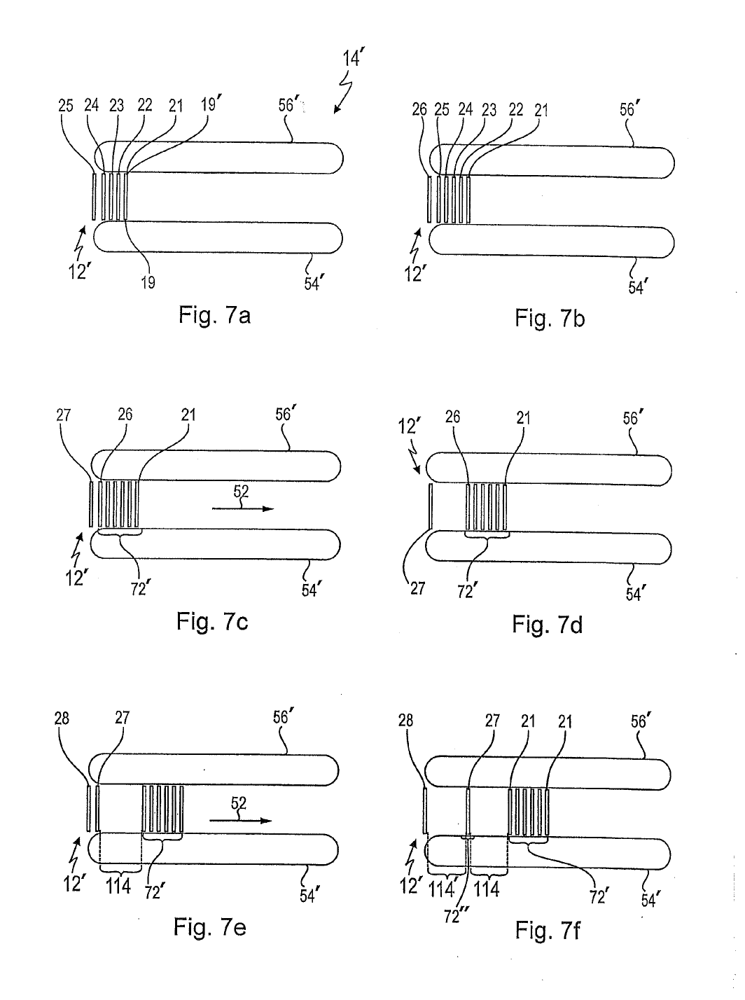

Here, for example, the control unit 100 regulates the division of envelopes 20 into different groups 72, as will be described in greater detail in the following in conjunction with FIGS. 7a to 7f.

To this end, the control unit 100 receives data from any desired second unit 104. This second unit 104 can itself be a constituent part of the device 10. Furthermore, it is conceivable that this is a constituent part of a machine which is positioned in front of the device 10 and is not shown in greater detail here. This can also be, for example, the enveloping machine which was mentioned in the introduction.

In the embodiment which is shown, the second unit 104 has a data acquisition device 106 which can be, for example, a camera (not shown) or a scanner.

This data acquisition device 106 forwards the detected data to the second unit 104 which then itself forwards these data to the control unit 100. This is shown by arrows 108 and 110. As an alternative to this, the data can also be forwarded directly from the data acquisition device 106 to the control unit 100, which is indicated here by an arrow 112.

The data which are transferred in each case in this way can reach the control unit 100 as raw data which the said control unit 100 then converts into corresponding control data or, however, have already previously been converted either in the second unit 104 or else in the data acquisition device 106 into corresponding data to be used by the control unit 100.

In one preferred embodiment, the control unit 100 controls the transport unit 14 and preferably also the transport unit 16 in such a way that it regulates the transport speed of the first transport elements 54 and 56 or the first and second transport elements 54, 56, 64 and 66.

This division of the envelopes 20 into any desired groups 71 is then to be explained in greater detail in the following with reference to FIGS. 7a to 7f.

FIG. 7a shows an initial situation, in which four envelopes 21 to 24 have already been received at their side edges 19 and 19′ by first transport elements 54′ and 56′ (shown diagrammatically here) in a transport unit 14′. Here, a further envelope 25 is still situated in the feeder 12′ and, as is shown by the transition from FIG. 7a to FIG. 7b, is likewise received into the transport unit 14′ between the first transport elements 54′ and 56′. Thereupon, a further envelope 26 moves up into the feeder 12′. This envelope 26 is also received into the transport unit 14′, as is shown by the transition from FIG. 7b to FIG. 7c, whereupon a further envelope 27 moves up. This sequence of receiving operations into the transport unit 14′ represents the normal case for receiving envelopes into a transport unit 14, 14′ in accordance with the present invention.

These envelopes 21 to 26 which are then shown in FIG. 7c are to form their own group 72′ which is to be transported spaced apart from the envelope 27 and all following envelopes.

To this end, the first transport elements 54′ and 56′ are briefly moved more rapidly in the direction of the transport direction 52. This takes place before the envelope 27 which is no longer to be part of the group 72′ is received into the transport unit 14′, that is to say between the first transport elements 54′ and 56′.

This more rapid movement or acceleration of the first transport elements 54′ and 56′ can be caused, for example, by the control unit 100. The latter has received information or data which cause a division between the envelope 26 and the envelope 27, for example, from the data acquisition device 106 or the second unit 104 in accordance with the comments made above. These data can be, for example, information about zip code regions, with the result that a change in the zip code regions lies, for example, between envelopes 26 and 27. The division into these separate zip code regions takes place on the basis of specific stipulations or agreements between the letter sender and the letter dispatch enterprise.

Returning back to FIGS. 7c and 7d, it is then seen in FIG. 7d that the group 72′ of the envelopes 21 to 26 is then spaced apart further from the envelope 27 as a result of the more rapid movement in the direction of the transport direction 52.

In the next step which is shown by the transition from FIG. 7d to FIG. 7e, the envelope 27 which is still present in the feeder 12′ is then received into the transport unit 14′ between the first transport elements 54′ and 56′. Here, a further envelope 28 then likewise moves up straight away in the feeder 12′, as can be seen in FIG. 7e. Furthermore, it can then be seen here that the envelope 27 and the envelopes 21 to 26 of the group 72′ are arranged in the transport unit 14′ spaced apart from one another at a spacing 114 and are also transported further in this way along the transport direction 52.

In the transition from FIG. 7e to FIG. 7f, furthermore, the case is shown where the envelope 27 is to form its own group 72″, for example likewise on the basis of data which the control unit 100 had obtained.

To this end, again in the transition from FIG. 7e to FIG. 7f, a brief acceleration or more rapid transport movement of the first transport elements 54′ and 56′ in the direction of the transport direction 52 takes place. Afterwards, there is likewise a greater spacing 114′ between the envelope 27 and the envelope 28. The envelope 27 therefore forms its own group 72′.

The groups 72′ and 72″ are then transported within the transport unit 14′, with reference to the illustration of FIG. 7f. The spacing 114, 114′ which is shown in FIGS. 7e and 7f is present between these two groups. Accordingly, a further spacing 114′ is also situated between the envelope 27 or the group 72″ and the following envelope 28 which belongs to its own further group (not shown) of envelopes.

These spacings between the groups, here 72′ and 72″ and the envelope 28, which are designated by the reference signs 114 and 114′ can be identical or else can also differ depending on the wishes and designs of the device 10 and preferably of the control unit 100.

The further transport of the groups 72′, 72″, etc. then takes place in accordance with the comments made above and in the process leads from a first transport unit 14 into preferably a second transport unit 16 in accordance with the method and the preceding description. From there, for example, the first group 72′ can then be transferred into a transport container 74 by releasing of the envelopes 21 to 26 from the second transport elements 64 and 66, and would therefore correspond to the above-described group 71. This takes place without impairment of the following groups 72″, etc. which are preferably still situated in a first transport unit 14 or 14′.

Furthermore, the transfer into the transport container 74 preferably takes place with the aid of a pusher 78, 78′ in accordance with the comments made above.

Even though the groups 71′, 71″, etc. described in FIGS. 7a to 7f are small groups of six or fewer envelopes, this can also be applied, in particular, to larger envelope quantities, as will occur during normal use of the device 10. The smaller quantities shown here have been selected merely for demonstration purposes. Here, in the case of the usual use of the device 10 according to the invention, however, envelope quantities of 20 or more envelopes are preferably assigned as a rule to a respective group.

What is claimed is:

1. A device for transporting flat products extending in a plane, comprising:
a first transport unit transporting said flat products in a transport direction, and
at least one feeder feeding said flat products to said first transport unit,
said first transport unit comprising at least two first transport elements,
said first transport elements being arranged parallel to said transport direction,
said flat products comprising side edges lying opposite to one another,
wherein said first transport elements can be set against said opposite side edges thereby gripping and separately holding said flat products and transporting said flat products with their plane being upright with respect to said transport direction.

2. The device of claim 1, further comprising:
at least one second transport unit, comprising at least one second transport element, said at least one second transport element transporting said flat products further in said transport direction and being arranged parallel to said transport direction, and said at least one second transport element being capable of removing said flat products from said device,
wherein said at least one second transport element can be set against at least one edge of said side edges of said flat products thereby gripping and separately holding said flat products and transporting said flat products with their plane being upright with respect to said transport direction.

3. The device of claim 2, wherein said second transport unit comprises:
two second transport elements,
said two second transport elements being arranged in a distance from one another, said distance can be varied perpendicularly with respect to said transport direction.

4. The device of claim 1, wherein at least each of said first transport elements of said first transport unit comprises:
at least one transport belt,
wherein said side edges of said flat products can be set onto said transport belts and
said side edges of said flat products can be gripped by said transport belts.

5. The device of claim 1, wherein said transport units comprise:
at least one further transport element that can be set against at least one further edge of said flat products.

6. The device of claim 5, wherein said at least one further edge is the lower edge of said flat products.

7. The device of claim 5, wherein each of said transport units comprises:
at least one further transport element.

8. The device of claim 7, wherein said at least one further edge is the lower edge of said flat products.

9. The device of claim 1, further comprising:
a pusher,
said pusher being capable of moving at least perpendicularly with respect to said transport direction and that it can be moved against an upper edge of said flat products.

10. The device of claim 9, wherein said pusher is capable of moving additionally in said transport direction.

11. The device of claim 1, further comprising:
a control unit,
said control unit controls at least said transport units.

12. The device of claim 1, further comprising:
a control unit,
said control unit controls at least said transport units and is designed to receive data from said feeder and to divide said flat products into separate groups of flat products in said device on the basis of said data, and
wherein said groups are separated from one another by spacings along said transport direction.

13. The device of claim 1, further comprising:
a control unit controlling at least said transport units, and
a second unit being positioned in front of said feeder,
said control unit being designed to receive data from said second unit and to divide said flat products into separate groups of flat products in said device on the basis of said data,
wherein said groups are separated from one another by spacings along said transport direction.

14. The device of claim 1, further comprising:
a control unit controlling at least said transport units, and
a second unit being connected to said feeder,
said control unit being designed to receive data from said second unit and to divide said flat products into separate groups of flat products in said device on the basis of said data,
wherein said groups are separated from one another by spacings along said transport direction.

15. A method for transporting flat products extending in a plane in a transport direction,
said flat products comprising side edges lying opposite one another,
said method comprising the following steps:
receiving of said flat products from a feeder into at least one first transport unit, said first transport unit having at least two first transport elements, and
transporting of said flat products within said first transport unit in said transport direction, wherein said flat products are separately held and gripped by said first transport elements at said side edges and are transported with their plane being upright with respect to said transport direction.

16. The method of claim 15, wherein said flat products are envelopes.

17. The method of claim 15, wherein said flat products are fed individually and said flat products being transported in said first transport unit are arranged parallel to one another and behind one another, and
wherein said flat products can be arranged at any desired spacing from one another with respect to said transport direction.

18. The method of claim 15, wherein said flat products are fed in small packets, and said flat products being transported in said first transport unit are arranged parallel to one another and behind one another, and
wherein said flat products can be arranged at any desired spacing from one another, seen in the direction of said transport direction.

19. The method of claim 15, further comprising the step of:
dividing said flat products from said feeder into separate groups of flat products within said first transport unit, by introducing spacings along said transport direction.

20. The method of claim 19, wherein said step of introducing said spacings comprises a brief increase in the transport speed of said first transport elements between the receiving of two of said flat products from said feeder.

21. The method of claim 15, further comprising the steps of:
continuous transferring said flat products from said first transport unit into at least one second transport unit having at least one second transport element,
further transporting said flat products within said second transport unit in said transport direction, wherein said flat products are separately held by said second transport element at least at one edge and are transported with their plane being upright with respect to said transport direction.

22. The method of claim 15, further comprising the step of:
removing said flat products from said second transport unit and transferring said flat products into a transport container.
